(19) United States
(12) Patent Application Publication
(10) Pub. No.: US 2005/0205366 A1
(43) Pub. Date: Sep. 22, 2005

(54) Large diameter brake disc having a thermal hinge

(75) Inventor: Ronald S. Plantan, Westlake, OH (US)

Correspondence Address: CROWELL & MORING LLP;INTELLECTUAL PROPERTY GROUP, P.O. BOX 14300, WASHINGTON, DC, 20044-4300, US

(73) Assignee: Bendix Commercial Vehicle Systems, L.L.C.

(21) Appl. No.: 10/803,051

(22) Filed: Mar. 18, 2004

(51) Int. Cl. F16D 55/00

(52) U.S. Cl. 188/71.1

(57) ABSTRACT

A brake disc for a vehicle which, when the brake disc is located on a hub end of a vehicle axle, places the friction portion of the brake disc closer to the center of the axle than a rim of a vehicle wheel mounted on the axle hub, such that the friction portion of the brake disc is outside of the wheel envelope. The friction surface of the brake disc located in this manner may have a greater radius than the inner wheel radius, thereby permitting increased braking torque to be generated, and is exposed to the cooling environment outside the wheel rim envelope. Heat transfer from the friction portion to the hub end of the vehicle axle may be inhibited by ring-shaped reduced-thickness sections, which may also serve as flexible hinges that permit the brake disc to flex to accommodate asymmetric loading by a brake caliper.

### BACKGROUND AND SUMMARY OF THE INVENTION

The present invention relates to disc brakes for vehicles and, in particular, to brake discs for air-operated disc brakes for commercial vehicles.

Pneumatically-operated disc brakes have been undergoing development and deployment on commercial vehicles since at least the 1970's, and are beginning to replace drum-style brakes due to advantages in areas such as cooling, fade resistance and serviceability. German patent publication DE 40 32 886 A1, and in particular FIG. 1 of this document, discloses an example of such an air disc brake. In this design, a pneumatic diaphragm chamber 12 is attached to a rear face of the disc brake caliper housing 3, and applies a brake actuation force through a linear actuator rod 10 to a brake actuator lever 9 within the caliper. The brake's actuator lever in turn transfers and multiplies the force applied by the actuator rod to one or more spindles 14, which force brake pads 20 against a brake disc or rotor 1. The terms “brake disc,” “rotor” and “brake rotor” are used interchangeably herein.

The adaptation of disc brake technology to commercial vehicle applications has not been without engineering challenges. Commercial vehicle wheel rims are sized, both in diameter and axial offset, to provide adequate clearance for the drum-type brakes historically employed on such vehicles. The resulting space envelope between the wheel and its axle is limited, leaving little space available for a pneumatic disc brake. Further, the deep offset of a typical commercial vehicle wheel essentially surrounds the axle hub and the brake mounted thereon, substantially inhibiting free flow of cooling air to the brake.

The combination of limited space and limited air flow within commercial vehicle wheels is a challenge to disc brake performance and longevity. For example, due to the limited inner diameter of commercial vehicle wheels, brake rotors located within the envelope defined by a wheel must also be limited in diameter. Accordingly, the kinetic energy of the vehicle that must be converted to heat energy in the brake in order to slow the vehicle must be deposited in a relatively small diameter disk, which in turn results in undesirably elevated disc temperatures. There are at least three concerns with such elevated disc temperatures, including disc dimensional instability (e.g., “warping”), shortening of disc service life due to accelerated disc cracking and wear, and excessive heat transfer from the high-temperature disc rotor hub to the vehicle's axle hub, hub bearings and other components. The resulting shortened component life can create a maintenance burden, deterring wider adoption of pneumatically-operated disc brake technology.

In addition to the limited space envelope, the shrouding of smaller-diameter brake discs by the enveloping wheel rims substantially limits the ability of cooling air flow to reach the discs. The wheel shrouding thus also contributes to excessive brake disc temperatures by limiting the disc's ability to reject heat generated during braking to the environment.

One approach to addressing these issues has been to design brake discs with enhanced cooling features, such as the brake disc disclosed in U.S. Pat. No. 6,626,273 B1, which is formed essentially as two parallel brake rotor friction surfaces joined with internal links to create internal ventilation ducts between the parallel surfaces. Internal ventilation in this manner effectively doubles the disc surface area exposed to the air for heat transfer, without increasing an outer diameter of the brake disc. In addition, brake discs have been developed to mechanically de-couple the brake rotor from its hub, such as the disc having splines disclosed in U.S. Pat. No. 6,564,913 B2. By so freeing the friction surfaces of the brake rotor from an integral or rigid, fixed mounting, mechanical stresses on the disc during braking (such as bending moments from uneven braking forces applied by the brake caliper and thermal expansion in the radial direction) are decreased. The reduction of mechanical stresses in turn allows the disc to tolerate higher thermally-induced stresses, and thus be able to absorb additional braking-generated heat.

Other approaches to dealing with the space constraints include configuring the disc brake caliper such that its thickness in a region directly above the brake rotor is minimized (thereby accommodating a larger diameter brake rotor), locating larger components which do not need to be located adjacent to the rotor (such as the brake's pneumatic actuator) on the side of the brake caliper, away from the wheel rim, and utilizing various high heat-tolerant disc materials, such as ceramic-matrix-composite (“CMC”) materials.

These approaches, while beneficial, also have some drawbacks. Ventilated rotors such as those in U.S. Pat. No. 6,626,273 B1 are typically very complex castings, and thus are costly in terms of both manufacturing process (e.g., labor and equipment-intensive mold preparation and casting processes) and process yield (i.e., relatively high defective casting rejection rates). Similarly, use of non-fixed brake rotors can require the production and use of a large number of individual component parts, increasing expense, assembly and possibly service efforts. Other alternatives also have their own limitations, such as the high cost of CMC-type materials (costs on the order of ten times greater than equivalent iron brake discs), and, in the case of a brake caliper configured to maximum disc diameter, the requirement for wheel removal in order to be able to access the brake pads for inspection or replacement.

Thus, despite the varying approaches to improving disc brake performance in the commercial wheel environment, the size and location of the wheel envelope remains a significant impediment to improved brake performance, life and serviceability.

In order to overcome the foregoing problems, it is an object of the present invention to provide a brake disc suitable for mounting on an axle of a commercial vehicle, such as by capturing the hub portion of the brake disc between the hub end of the axle and a wheel bolted to the axle hub, wherein the brake disc extends sufficiently far toward the center of the vehicle to permit the friction surface portion of the brake disc to be located outside of the wheel envelope and to have a radius larger than the radius of the wheel rim.

It is a further object to provide a brake disc with a friction portion outside of the wheel envelope, wherein the brake disc is equipped with a heat-conduction blocking section to minimize braking heat transfer from the friction surface portion to both the portion of brake disc connecting the friction surface to the hub portion and to the hub portion. Inhibiting heat transfer to these portions of the brake disc minimizes braking heat transfer to the vehicle axle hub and axle, and provides a flexible region which permits the friction surface portion of the brake disc to flex to accommodate minor dimensional variations and misalignments between the brake disc, the caliper and the caliper mounts.

An additional object is to provide a brake disc with a friction portion outside of the wheel envelope which is equipped with an array of cooling fins at the root of the friction surface portion to further minimize braking heat transfer from the friction surface portion to the connecting portion. Another object is to provide additional heat conduction blocking surfaces and/or ventilation apertures in the brake disc connecting portion to further minimize braking heat transfer to the hub portion and the axle hub and to enhance axle cooling in the region of the axle shrouded by the brake disc.

The present invention's location of the brake disc's friction surface outside the envelope of a vehicle's wheel rim has a number of advantages. The direct exposure of brake components to the cooling air stream greatly enhances brake component cooling, and as a result the need for complex, expensive ventilated rotors is decreased and may be altogether eliminated. The increased cooling of the disk also reduces the amount of heat transferred to the hub portion of the rotor and the vehicle axle, and helps reduce or eliminate brake fade that can otherwise occur when sustained braking results in an overheated brake condition. This rotor positioning also offers substantially improved brake inspection and servicing, as the friction portion of the brake disc, the caliper and the brake pads are no longer shrouded by the vehicle wheel. In particular, this arrangement permits immediate visual inspection of brake pads and reduction of pad replacement time to mere minutes due to the elimination of the need to jack up the vehicle axle and remove one or more wheels to access the brake.

Additional benefits of increasing the brake disc outer diameter beyond the wheel rim include an increase in rotor mass at the outer periphery of the rotor for absorption of additional braking heat energy, thereby helping lower rotor peak temperature.

The increased rotor diameter also results in a corresponding decrease in the forces and stresses applied to the brake caliper. For example, in order to obtain the same level of braking torque at the wheel as achieved by a disc brake within the wheel envelope, the larger diameter rotor's increased moment arm about the vehicle axle means its caliper can apply a smaller clamping force to the disc to generate the same torque (the applied clamping force being smaller in proportion to the increase in rotor diameter).

Alternatively, for the same level of caliper clamping force, the larger diameter brake disc can generate a greater braking torque than a within-wheel brake disc. In those applications where greater braking torque is not required, the reduced caliper stresses resulting from the larger diameter rotor offers the further benefit of permitting the caliper design to be further optimized. For example, because the caliper need only be designed to withstand lower loads, a simplified and smaller caliper and mounting structure may be employed, with commensurate reductions in weight and manufacturing costs.

The inclusion of flexible hinges in the present invention brake disc has the further advantages of lowering cost and decreasing manufacturing and servicing complexity. By including flexible regions, which can accommodate stresses caused by bending loads and radial expansion in a one-piece brake disc (or in a multi-part brake disc built up from components rigidly affixed to one another), the present invention can eliminate the need for complicated, expensive brake disc assemblies which rely on movable rotor-to-hub joints to accommodate these stresses.

Other objects, advantages and novel features of the present invention will become apparent from the following detailed description of the invention when considered in conjunction with the accompanying drawings.

### BRIEF DESCRIPTION OF THE DRAWINGS

FIG. 1 is a cross-sectional view of a brake disc in accordance with an embodiment of the present invention.

FIG. 2 is a cross-section view of the brake disc of FIG. 1 schematically illustrating the relative positioning of components when the rotor is captured between an axle hub and a wheel rim.

### DETAILED DESCRIPTION OF THE DRAWINGS

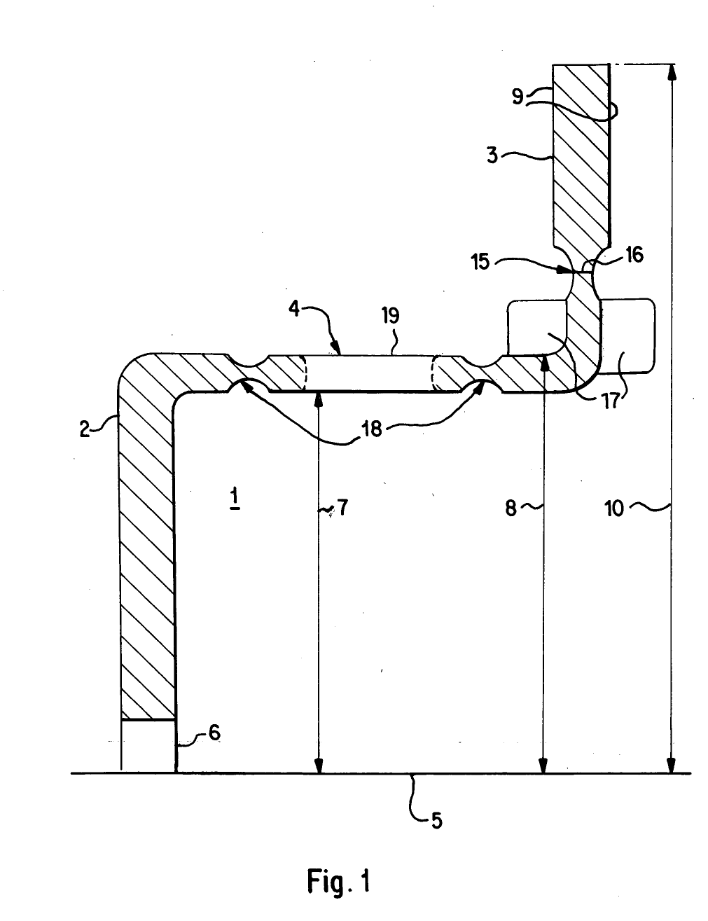

FIG. 1 is a cross sectional view of one-half of a brake disc 1. The brake disc 1 includes a hub portion 2, a friction portion 3 and a connecting flange portion 4. Brake disc 1, when located on the hub end of a vehicle axle (not illustrated in FIG. 1 for clarity), rotates about axle hub rotating axis 5. The center of hub portion 2 may include an aperture 6 configured to interface with the hub end of the axle to center rotor 1 about hub rotating axis 5. A symmetrical portion of brake disc 1 below hub rotating axis 5 is not shown for clarity.

In this embodiment of the present invention, connecting portion 4 is formed as a one-piece extension of hub portion 2, which extends from the hub portion at hub portion outer radius 7 to an inner radius 8 of friction portion 3. Alternatively, brake disc 1 may be a multi-piece structure built-up from subassemblies, such as an integral hub and connecting flange section to which a replaceable friction surface section is secured.

Connecting flange portion 4 may be, as shown in FIG. 1, a cylinder-shaped portion disposed concentrically about hub rotation axis 5. Connecting flange portion 4 is not restricted to a cylindrical shape, but may be any shape, such as a truncated cone, as long as the connecting portion connects the hub portion to the friction portion without interfering with the vehicle axle as the brake disc rotates about the axle hub end, and does not contact the wheel rim when a wheel is affixed to the hub end of the axle, i.e., as long as connecting flange portion 4 remains within a space envelope defined by the vehicle axle (including protrusions therefrom, such as flanges or brackets) and an inner surface of the wheel rim.

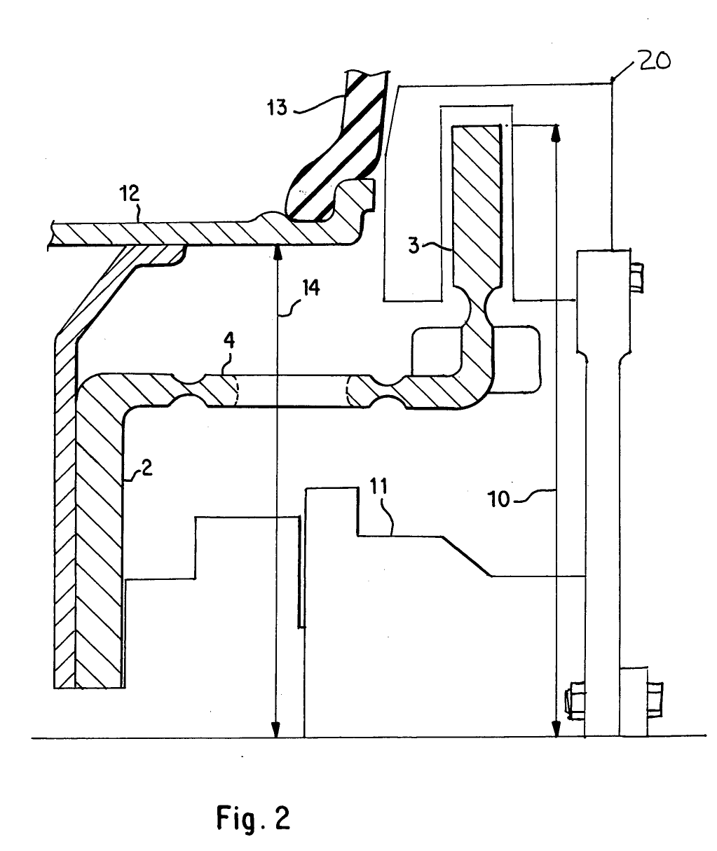

Friction portion 3 includes friction faces 9 against which disc brake linings (not shown) are applied to generate braking forces. In this embodiment, friction faces 9 extend to an outer radius 10 of friction portion 3. As schematically illustrated in FIG. 2, connecting flange portion 4 extends toward the center of vehicle axle 11 far enough to place friction portion 3 outside the envelope of wheel 12 and tire 13 when the wheel is mounted on vehicle axle 11, and therefore the brake disc outer radius 10 may extend substantially beyond the wheel rim inner radius 14. The increased brake disc radius possible at this displaced location permits the generation of greater braking torque for a given amount of disc brake lining application force than could be generated by a brake disc small enough to fit within wheel inner radius 14. This brake disc configuration also permits improved brake cooling by placing the friction surface portion of the brake disc out in a cooling air region rather than within the relatively shrouded region within wheel 12.

Located between friction faces 9 and connecting flange portion 4 is heat conduction limiting section 15. This annular reduced-thickness section of friction portion 3 acts as a heat transfer block, inhibiting the transfer of heat energy (generated by the rubbing of the friction linings against friction faces 9) from friction portion 3 to connecting flange portion 4. Heat transfer is inhibited because the reduced cross-sectional area 16 acts as a heat conduction “choke point,” limiting the rate at which heat energy can be transferred toward friction portion inner radius 8. While the drawing shows a symmetrically curved indentation forming the heat conduction limiting section 15, any reduced section shape may be employed.

In addition, the reduced thickness of heat conduction limiting section 15 allows heat conduction limiting section 15 to function as a limited-flexibility hinge, such that when friction faces 9 are loaded in an asymmetric manner, the portion of friction surface 3 radially outboard of heat conduction limiting section 15 can flex a limited distance to accommodate the uneven loading. In addition to allowing improved brake lining-to-rotor contact alignment, the limited flexibility provided by heat conduction limiting section 15 reduces the need for the brake caliper and its mounting system to have to accommodate alignment and dimension variations, thereby enabling simplified design and lower cost production of these components.

A further embodiment of the present invention includes a plurality of cooling fins 17 arrayed about friction portion 3 at inner radius 8 to enhance heat transfer from friction portion 3 to the environment, thereby further minimizing the amount of heat energy which reaches connecting flange portion 4. Such cooling fins may be formed in any number of well-known ways, such as being integrally cast with brake disc 1, being machined on the brake disc, or being formed on a separate ring and then affixed to the brake disc by conventional means, such as bolting. Other enhanced cooling arrangements which inhibit heat transfer to the body of the connecting flange portion may also be provided, such as an array of cooling fins about the inner radius of the connecting flange directly adjacent to the friction portion, as long as there is no interference with any adjacent projections from the vehicle axle.

Another embodiment may locate one or more circumferential reduced-thickness heat conduction limiting sections 18, similar to heat conduction limiting section 15, on connecting flange portion 4 to inhibit heat transfer from friction portion 3 to hub portion 2 and the hub end of the vehicle axle. These heat conducting limiting sections 18 may be included either in addition to, or instead of, one or more heat conduction limiting sections 15 below friction surfaces 9 in order to further limit heat transfer to the hub area.

In a further embodiment of the present invention, additional cooling of the hub end of brake disc 1 and the vehicle axle is provided by ventilation apertures 19 spaced about the circumference of connecting flange portion 4 which encourage air flow through the region between the hub end of the axle and connecting flange portion 4. [[[FOR THE INVENTOR: ARE OPENINGS ALSO ENVISIONED IN THE FRICTION SURFACE PORTION? (i.e., between the friction faces 9 and the thermal hinge 15?)]]]

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A brake disc, comprising:
a hub portion;
a friction portion, said friction portion formed as a generally planar ring; and
a connecting flange portion, wherein
the connecting flange portion extends from an outer radius of the hub portion to an inner radius of the friction portion,
the connecting flange portion has a length such that when the hub portion and a wheel rim adapted to be mounted on a hub end of a vehicle axle are located at the hub end of the axle, the friction portion is outboard of the wheel rim, and
the friction portion has an outer radius greater than an inner radius of the wheel rim.

2. The brake disc of claim 1, wherein the connecting flange portion is cylindrical.

3. The brake disc of claim 1, wherein the brake disc is a one-piece brake disc.

4. The brake disc of claim 1, wherein at least one heat-conduction limiting section is provided on at least one of the connecting flange portion and the friction portion.

5. The brake disc of claim 4, wherein the at least one heat-conduction limiting section includes a section having a reduced thickness.

6. The brake disc of claim 5, wherein the reduced thickness section is shaped as a ring.

7. The brake disc of claim 1, wherein at least one ventilation aperture is provided in the connecting flange portion.

8. The brake disc of claim 5, wherein at least one ventilation aperture is provided in the connecting flange portion.

9. The brake disc of claim 6, wherein at least one ventilation aperture is provided in the connecting flange portion.

10. The brake disc of claim 1, wherein a plurality of cooling fins are disposed about an inner radius of the friction portion.

11. The brake disc of claim 5, wherein a plurality of cooling fins are disposed about an inner radius of the friction portion.

12. The brake disc of claim 6, wherein a plurality of cooling fins are disposed about an inner radius of the friction portion.

13. The brake disc of claim 7, wherein a plurality of cooling fins are disposed about an inner radius of the friction portion.

14. The brake disc of claim 8, wherein a plurality of cooling fins are disposed about an inner radius of the friction portion.

15. The brake disc of claim 9, wherein a plurality of cooling fins are disposed about an inner radius of the friction portion.

16. A vehicle axle assembly, comprising:
a vehicle axle; and
a disc brake disposed at a hub end of the vehicle axle, the disc brake including:
a brake caliper adapted to be affixed to a caliper mount on the vehicle axle, and
a brake disc disposed on the hub end of the vehicle axle such that a braking force generated by the brake caliper is applied to the brake disc, the brake disc including:
a hub portion;
a friction portion, said friction portion formed as a generally planar ring; and
a connecting flange portion, wherein
the connecting flange portion extends from an outer radius of the hub portion to an inner radius of the friction portion,
the connecting flange portion has a length such that when the hub portion and a wheel rim adapted to be mounted on a hub end of a vehicle axle are located at the hub end of the axle, the friction portion is outboard of the wheel rim, and
the friction portion has an outer radius greater than an inner radius of the wheel rim.

17. The axle assembly of claim 16, wherein at least one heat-conduction limiting section is provided on at least one of the connecting flange portion and the friction portion.

18. The axle assembly of claim 17, wherein the at least one heat-conduction limiting section includes a section having a reduced thickness.

19. The axle assembly of claim 18, wherein the reduced thickness section is shaped as a ring.

20. The axle assembly of claim 16, wherein at least one ventilation aperture is provided in the connecting flange portion.

21. The axle assembly of claim 18, wherein at least one ventilation aperture is provided in the connecting flange portion.

22. The axle assembly of claim 19, wherein at least one ventilation aperture is provided in the connecting flange portion.

23. The axle assembly of claim 16, wherein a plurality of cooling fins are disposed about an inner radius of the friction portion.

24. The axle assembly of claim 18, wherein a plurality of cooling fins are disposed about an inner radius of the friction portion.

25. The axle assembly of claim 19, wherein a plurality of cooling fins are disposed about an inner radius of the friction portion.

26. The axle assembly of claim 20, wherein a plurality of cooling fins are disposed about an inner radius of the friction portion.

27. The axle assembly of claim 21, wherein a plurality of cooling fins are disposed about an inner radius of the friction portion.

28. The axle assembly of claim 22, wherein a plurality of cooling fins are disposed about an inner radius of the friction portion.
